(19) United States
(12) Patent Application Publication
(10) Pub. No.: US 2015/0249875 A1
(43) Pub. Date: Sep. 3, 2015

(54) MULTIMEDIA DEVICE

(71) Applicant: Jaren HIGGINBOTHAM, Shawnee, KS (US)

(72) Inventor: Jaren HIGGINBOTHAM, Shawnee, KS (US)

(21) Appl. No.: 14/636,990

(22) Filed: Mar. 3, 2015

Related U.S. Application Data
(60) Provisional application No. 61/947,208, filed on Mar. 3, 2014.

(51) Int. Cl. H04R 1/02

(52) U.S. Cl. CPC H04R 1/021; H04R 1/028

(57) ABSTRACT

A multimedia device includes electrical circuitry and a rechargeable power source connected to audio circuitry, stored multimedia data, and a speaker within a weatherproof housing for playback of media. An operator initiates playback of the media by energizing a capacitor assembly by rotation of a dynamo operably connected to a hub at the exterior of the device. The power circuitry monitors charging of the capacitor assembly and permits playback of the multimedia data when the capacitors contain enough energy to playback the data.

### CROSS-REFERENCE TO RELATED APPLICATIONS

The application claims the benefit of U.S. Provisional Application No. 61/947,208, filed Mar. 3, 2014, the contents of which are hereby incorporated by reference.

### BACKGROUND

The disclosed subject matter relates to multimedia devices. In particular, the disclosed subject matter relates to a multimedia device that can be used in an environment that does not have electrical service.

Printed signage has long provided people with information about a particular place they are visiting, such as a historical landmark or gravesite, or information about where to go, such as directions. Printed signage containing information that does not need updating can be installed in remote locations, and does not need electrical service to operate.

It can be time consuming and cumbersome updating the information on printed signage, especially if the signage is in a remote location. As a result, signage is limited in the information it can convey. Devices containing recorded audio and video information are limited in their placement and utility by their need for access to electrical service.

Heretofore there has not been available a multimedia device with the advantages and features of the disclosed subject matter.

### SUMMARY

A multimedia device with a rechargeable power source and stored multimedia data is contained within a weatherproof housing. The electronic device includes audio circuitry coupled to power circuitry within the housing. The audio circuitry includes media storing multimedia data, including audio, played through a speaker. An operator initiates playback of the multimedia data by first powering the device. The power source of the device includes circuitry connecting the audio circuitry to a capacitor assembly or a rechargeable battery storing a charge. The power circuitry monitors charging of the power source and permits playback of the multimedia data when the power source includes enough energy to playback the multimedia data.

In an embodiment, a dynamo is rotated by an operator to charge the power source. In an embodiment, charging of the power source is via a fob with a battery held to a connector at the exterior of the device by a user.

A counter device connected to the device circuitry records the number of times the device plays the multimedia data.

The device is enclosed within a weatherproof housing sealed against the elements, with a weatherproof speaker, weatherproof switches, and weatherproof indicator lights. The device can be mounted or connected to an object by its back plate.

### BRIEF DESCRIPTION OF THE DRAWINGS

The drawings constitute a part of this specification and include exemplary embodiments of the disclosed subject matter and illustrate various objects and features thereof.

FIG. 1 is a perspective view of an illustrative multimedia device embodying principles of the disclosed subject matter.

FIG. 2 is an isometric view from below of the multimedia device embodying principles of the disclosed subject matter.

FIG. 3 is a bottom plan view of the multimedia device embodying principles of the disclosed subject matter.

FIG. 4 is an exploded view of the multimedia device embodying principles of the disclosed subject matter.

FIG. 5 is a schematic of an exemplary embodiment of a multimedia device embodying principles of the disclosed subject matter.

FIG. 6 is a schematic of an exemplary power assembly.

FIG. 7 is a schematic of an exemplary control panel assembly.

FIG. 8 is a schematic of an exemplary audio assembly.

FIG. 9 is a schematic of an embodiment of a power assembly embodying principles of the disclosed subject matter.

FIG. 10 is a schematic of an embodiment of an audio assembly embodying principles of the disclosed subject matter.

FIG. 11 is a schematic of an embodiment of a control panel assembly embodying principles of the disclosed subject matter.

### DETAILED DESCRIPTION

As required, detailed aspects of the disclosed subject matter are disclosed herein; however, it is to be understood that the disclosed aspects are merely exemplary of the disclosed subject matter, which may be embodied in various forms. Therefore, specific structural and functional details disclosed herein are not to be interpreted as limiting, but merely as a basis for the claims and as a representative basis for teaching one skilled in the art how to variously employ the disclosed technology in virtually any appropriately detailed structure.

Certain terminology will be used in the following description for convenience in reference only and will not be limiting. For example, up, down, front, back, right and left refer to the disclosed subject matter as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

Referring to the drawings and specification an embodiment of a multimedia device embodying principles of the disclosed subject matter is shown and described herein. The illustrative multimedia device 100 includes electrical and mechanical components within a housing 102. The electrical and mechanical components include a power assembly 200 operably connected to a control panel assembly 300 and an audio assembly 400. The multimedia device 100 allows the recording, storing, and playback of audio and video data for playback to an operator.

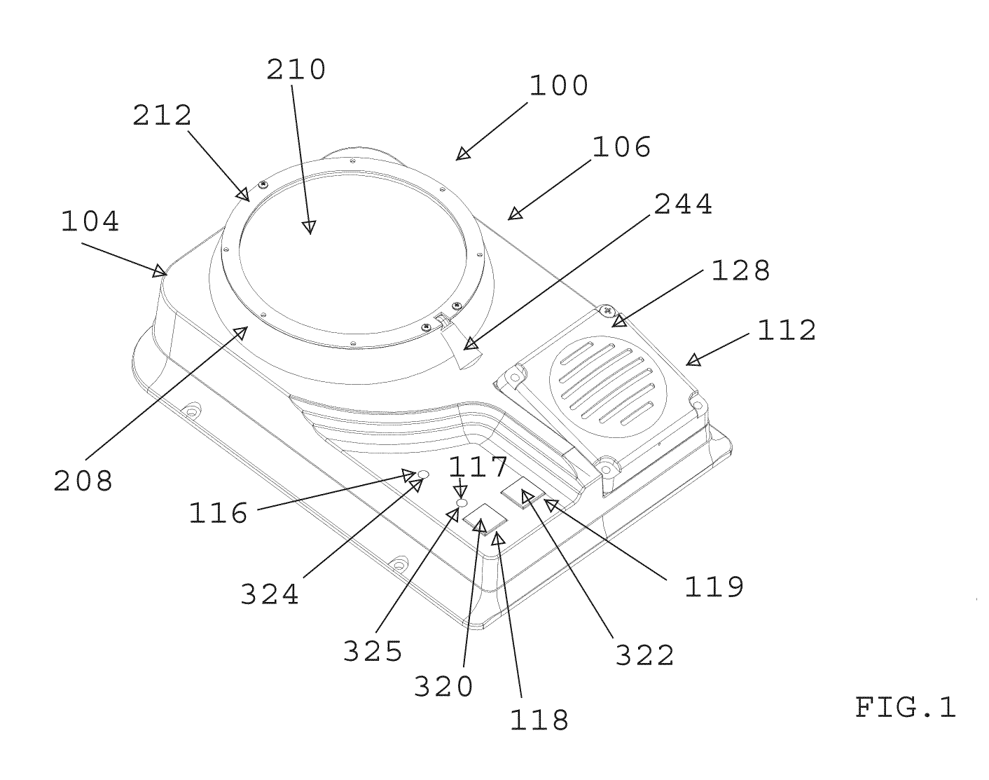

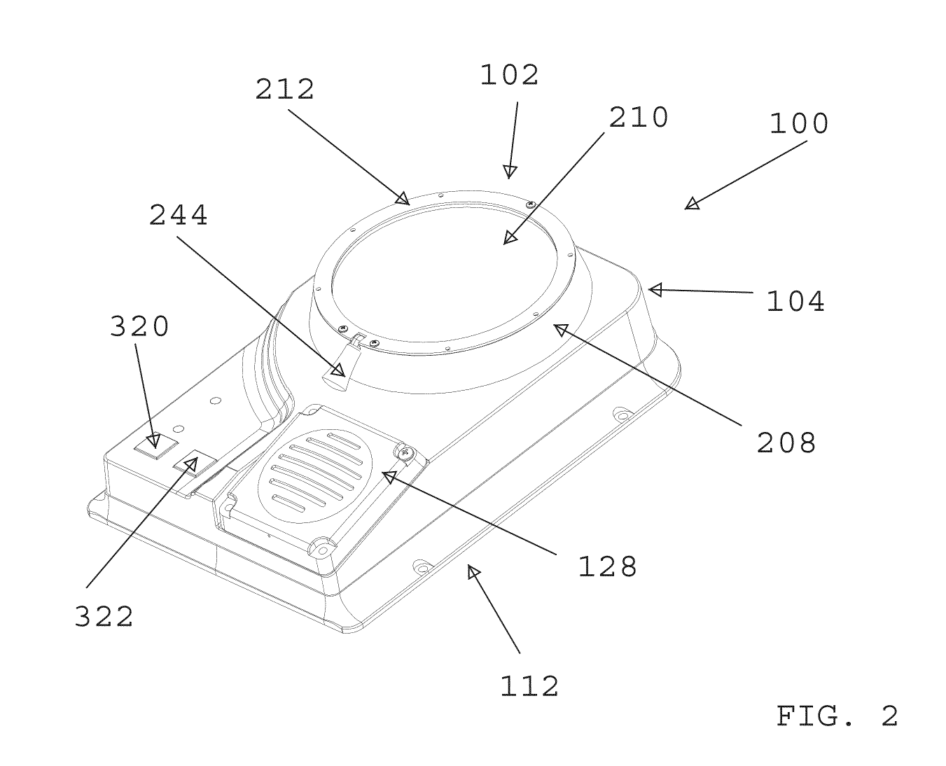

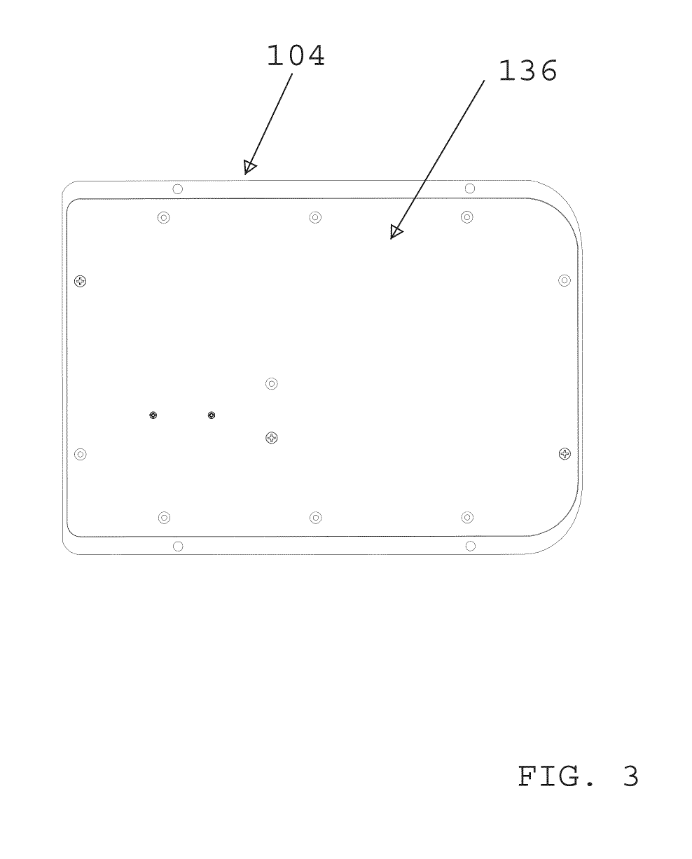

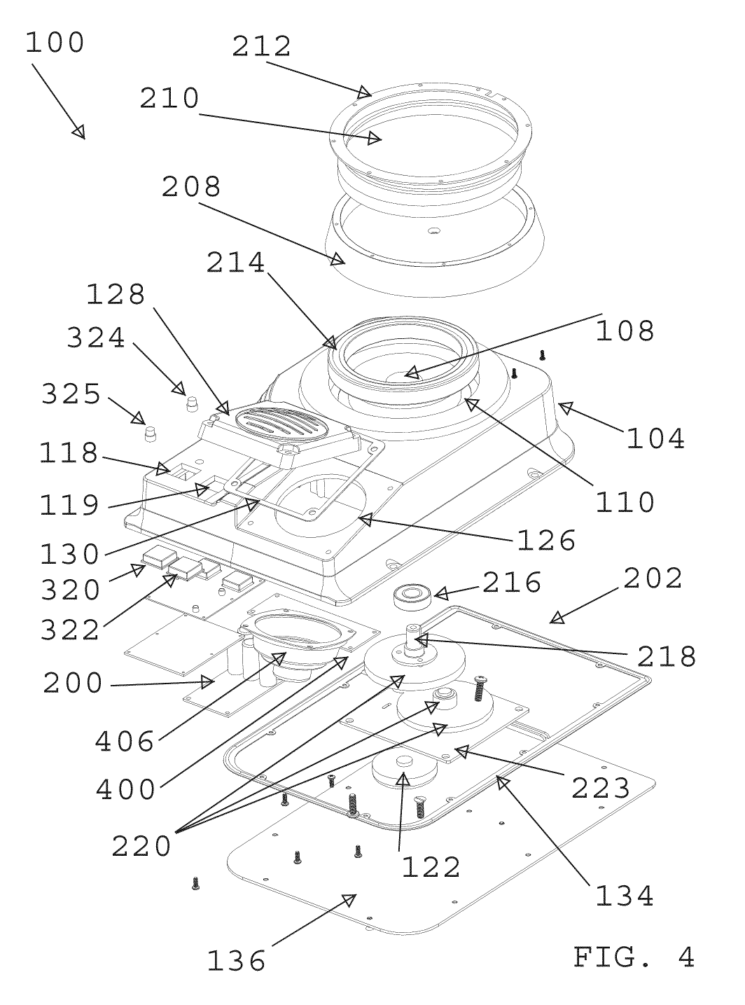

Referring to FIGS. 1-4, an embodiment of the housing 102 includes a body 104 secured to a baseplate 136. An upper portion 106 of the body 104 forms an opening 108 surrounded by a recess 110. The opening 108 and recess 110 accommodate components of the mechanical power source 202. A lower portion 112 of the body 104 forms light openings 116 and 117, button openings 118 and 119, and speaker opening 126. Light openings 116 and 117 accommodate indicator lights 324 and 325, respectively of the control panel assembly 300. Button openings 118 and 119 accommodate actuator buttons 320 and 322, respectively of the control panel assembly 300. Speaker opening 126 accommodates an electroacoustic transducer or speaker 406 and speaker cone of the audio assembly 400. A gasket 130 seals a speaker cover 128 secured to the lower portion 112 over the speaker opening 126. A gasket 134 seals the baseplate 136 secured to the bottom of the body 104. The buttons 320, 322 and openings 118, 119, and indicator lights 324, 325 and light openings 117, 118 are weatherproof. The housing 102 provides all weather protection for the device 100. In an embodiment, the housing 102 is manufactured from aluminum.

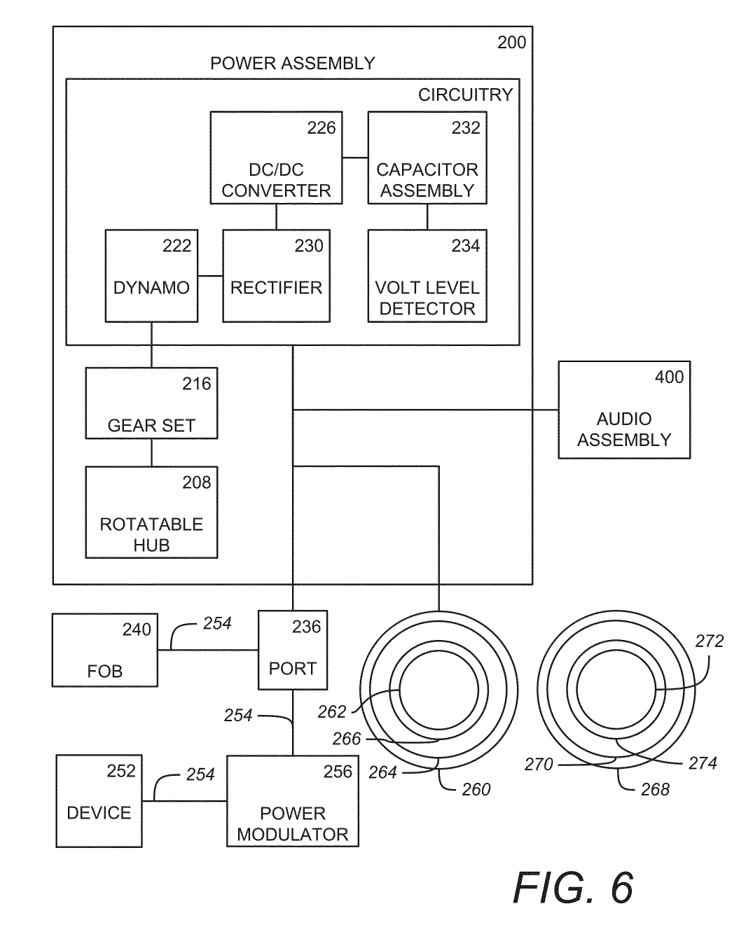

Referring to FIG. 6, the power assembly 200 includes circuitry connecting the various components and provides electrical energy or supply voltage for the multimedia device 100 from a power source 202. The power source 202 is one or more of generated energy or stored energy. In an embodiment, the power source 202 is a capacitor assembly 232 storing electrical energy mechanically generated by a dynamo 222.

The dynamo 222 is mechanically connected to a rotatable hub 208 by a gear set 220 mounted to a gear plate 223. The hub 208 is a disc-shaped member at the exterior of the body 104. The hub 208 receives a disk 210 providing a surface for an image. The disk 210 is a durable, long lasting material capable of receiving an image, such as a picture of an animal, object, or geographical feature. The disk 210 is secured to the hub 208 by a retaining ring 212. The hub 208 rests on a bearing 214 received in the recess 110 at the exterior of the body 104. The hub 208 is connected to the gear set 220 by a shaft 218 that extends from the gear set 216 through a bearing 216 disposed in the opening 108. Rotation of the hub 208 rotates the dynamo 222 generating electricity for the multimedia device 100. In an embodiment, the gear set 216 has a reduction ratio of about 27:1 to generate the torque, voltage, and current necessary for the dynamo 222 to charge the capacitor assembly 232. Circuitry connects the dynamo 222 to other electrical components, including the capacitor assembly 232. In an embodiment, the hub 208 is rotated between about 60 rotations to about 80 rotations per minute. The dynamo 222 generates between about 9 volts to about 16 volts AC, and between about 0.5 ampere to about 1 ampere of current. In an embodiment, the dynamo 222 is a 20 watt brushless dynamo. The reduced friction of a brushless dynamo provides a greater service life of the mechanical electrical generation source. The dynamo 222 and capacitor assembly 232 are connected through a rectifier 230 and a first DC to DC converter 226. The rectifier 230 converts the 3 phase AC output of the dynamo 222 to DC. The first converter 226 is a step down converter. The first converter 226 receives the DC voltage from the rectifier 230 and conditions and reduces the voltage and current ultimately entering the capacitor assembly 232. In an embodiment, the first converter 226 outputs approximately 8.2 volts DC at a constant current of about 0.5 ampere, charging the capacitor 232 and protecting the capacitor assembly 232 from over voltage damage.

In an embodiment, the capacitor assembly 232 includes a first set of three double layer capacitors connected in a series. In an embodiment, the capacitor assembly 232 includes a second set of three double layer capacitors are connected in a series that are also connected to the first set in parallel, providing a stored usable voltage of between about 3.8 volts DC to about 8.2 volts DC, supporting an output load of between about 40 milliamps to about 130 milliamps, and providing about 7 minutes of playing time of the data stored on the media 410. In an embodiment, the capacitors are 10 farad super capacitors. In an embodiment, the capacitor assembly 232 has a capacitance of about 10 farads. Additional circuitry may be added to avoid overcharging the capacitor assembly 232 and balance the load on the capacitor.

In an embodiment, the electrical energy is stored in a rechargeable battery instead of a capacitor assembly 232. In an embodiment, the battery stores enough power to operate the device 100 for a period of time beyond the playback timeframe of the recorded data.

In an embodiment, the power source 202 is a domestic energy source, such as an electrical utility provider. In an embodiment, the power source 202 is electrical energy provided by photovoltaic cells. In an embodiment, the power source 202 is a piezoelectric source. In an embodiment, the power source 202 is a battery.

In an embodiment, the power source 202 is an external device, including a battery in a fob 240 that is held to the device 100 by an operator. In an embodiment, the battery in the fob 240 directly powers the device 100. In an embodiment, the fob 240 conveys electrical energy to the capacitor assembly 232 or a rechargeable battery. The fob 240 can be the size of a key fob for an automobile. In an embodiment, a port 236 connected to the power assembly 200 and accessible from the exterior of the housing 102 allows the fob 240 to be mechanically connected to the port 236 by a connector 254 or wire assembly for discharging the battery and charging either the capacitor assembly 232 or an internal battery.

In an embodiment, a port 260 connected to the power assembly 200 and accessible from the exterior of the housing 102 has a contact assembly connected to the power supply 200 for connection with a contact assembly of a fob 268 connected to a battery for discharging the battery and transferring voltage from the fob 268 to the device 100 charging either the capacitor assembly 232 or an internal battery. The port 260 contact assembly includes a first generally planar contact 262 surface and a second generally planar contact 264 surface separated by an insulator 266. In an embodiment, the first and second contacts 262, 264 are concentric. The fob 268 contact assembly includes a generally planar first contact 270 surface and a second generally planar contact 272 surface separated by an insulator 274. In an embodiment, the port 260 contact assembly compliments the fob 268 contact assembly. In an embodiment, the first and second contacts 270, 272 are concentric. In an embodiment, the first contact assembly 270 on the fob 268 is brought into contact with a second contact assembly 264 at the exterior of the housing 102. Pins may be incorporated with the contact assemblies to prevent vandalism. The fob 268 may include a magnet where the magnet retains the fob 268 contact assembly in contact with the port 260 contact assembly while transferring the electrical charge. The transfer of electrical charge is activated by the operator pressing a button on the fob 268. As the charge is transferred from the fob 268 to the power source 202 indicator light 325 illuminates indicating the power source 202 is being charged. Once the power source 202 has received a full charge, indicator light 324 illuminates indicating the power source 202 has enough energy to operate the device 100 for the time period necessary to playback the data on the media 410.

In an embodiment, the power source 202 is an external device, including a battery powered portable operator device 252, such as a smart phone, table, laptop, etc. that is mechanically connected to the power assembly 200 by a connector 254 or wire assembly. In an embodiment, the portable operator device 252 provides electrical power to the capacitor assembly 232 through the port 236. In an embodiment, the portable operator device 252 provides electrical power to an internal battery. A power modulator can be included in-line between the operator portable device 252 and the capacitor 232 for controlling the transfer of electrical energy. The media 410 includes instructions for the processor 412 for charging the power source 202 from the portable operator device 252. In an embodiment, the power source 202 can be used to charge the portable operator device 252. In an embodiment, audio data on the portable operator device 252 is played through the speaker 406. In an embodiment, an operator can download audio data associated with the location where the device 100 is used. For example, if the device 100 is installed for use at a park with a scenic overlook, an operator can download audio data from a website associated with the park, and the operator can connect their portable operator device 252 to the device 100, either using the connector 254 or the radio frequency transceiver 432, and playback the audio through the speaker 406.

In an embodiment, the power source of the portable operator device 252 can be recharged by the device 100 by connecting the portable operator device 252 to the port 236 with a connector 254, and rotating the dynamo 222.

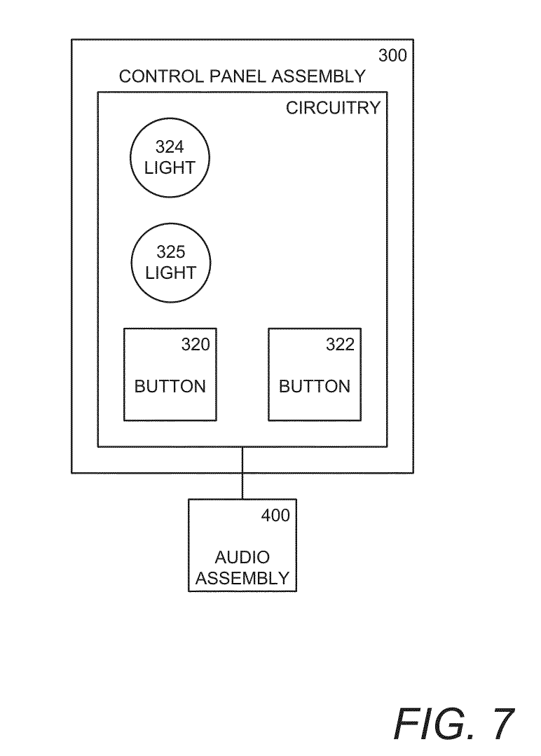

Referring to FIG. 7, the control panel assembly 300 includes circuitry connecting mechanical and electrical components for operating the multimedia device 100. Indicator light 324 visible through the light opening 116 shows an operator the status of the device 100. Indicator light 325 illuminates when an operator is rotating the hub 208 fast enough to generate electricity from the dynamo 222, or when electricity is being transferred to the capacitor assembly 232 or internal battery, such as from a powered portable operator device 252 or a fob 240. Indicator light 324 illuminates when the power source 202 has enough energy to operate the device 100 for the time period necessary to playback the data on the media 410.

Actuation buttons allow an operator to control the device 100. A first switch is connected to button 320 and actuated for adjusting the volume level of the audio data played through the speaker 406. In an embodiment, button 320 toggles between a low, middle, and high volume level. A second switch is connected to button 322 and actuated for starting, pausing, and stopping playback of the recorded data. In an embodiment, an optional third switch connected to a button is actuated for rewinding, fast forwarding, and skipping portions of the recorded audio or video data as it is played. In an embodiment, the buttons are momentary switches.

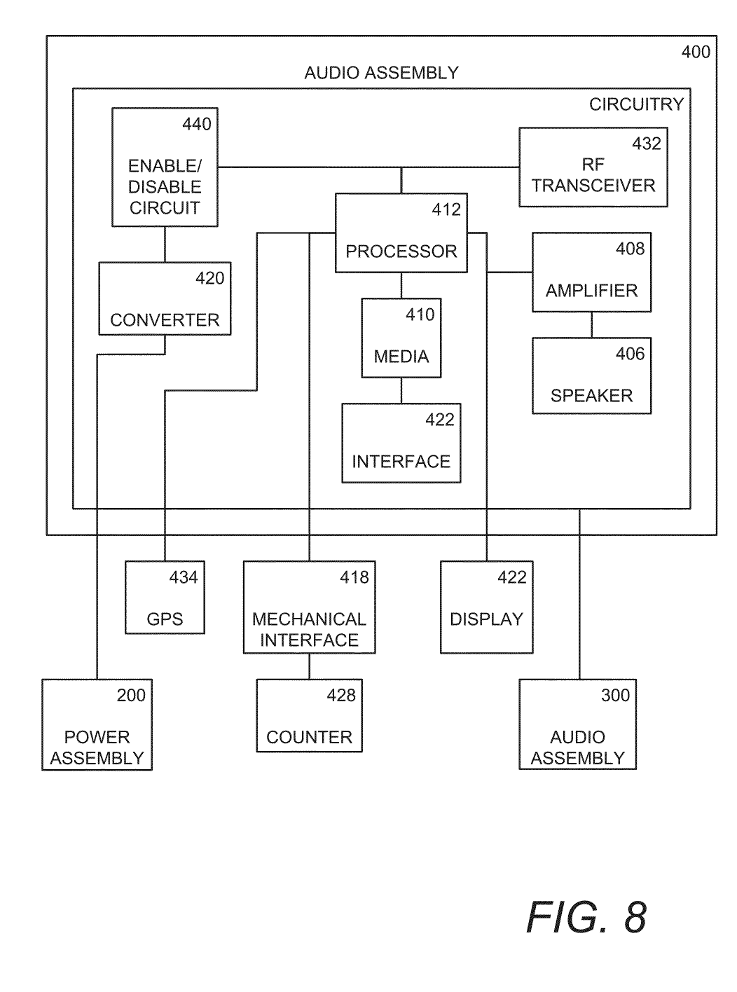

Referring to FIG. 8, the multimedia or audio assembly 400 includes circuitry connecting mechanical and electrical components for operating the multimedia device 100. The audio assembly 400 includes a processor 412 connected by circuitry to the power assembly 200, the control panel assembly 300, and the operator interface. The processor 412 provides operational management of the device 100 including management of the power assembly 200, audio assembly 400, and operator interface including the control panel assembly 300 and the programming interface. The processor 412 is connected to computer readable media 410 containing instructions for the processor 412 for playback of the data file from the media 410. The terms “computer readable medium” and “computer readable media” can be used interchangeably to mean storage that can be accessed by a processor. These terms include temporary transitory storage (such as data caches used by web browsers, streaming media players and digital video recorders), provided that neither term is intended to include any propagated signal, any carrier wave or any other non-statutory subject matter. The media 410 carries or stores the necessary program code in the form of machine-executable instructions or data structures which can be accessed by the processor 412.

Electrical power is provided to the processor 412 and an amplifier 408 by the power assembly 200. In an embodiment, when the power source 202 is the capacitor assembly 232, the electrical power passes through a second DC to DC converter 420 connected to an enable/disable circuit 440 in route to the processor 412 and amplifier 408. The second converter 420 receives input voltage from the capacitor 232 from about 3.5 volts DC to about 8.2 volts DC, and outputs between about 3.7 volts DC to about 3.8 volts DC at about between 60 milliamps to about 150 milliamps of current to the processor 412 and audio amplifier 408.

The media 410 stores data including an audio file containing sound or a spoken message. In an embodiment, the media 410 stores video data. In an embodiment, the media 410 is a flash storage device. In an embodiment, the length of playback of the stored data is between about 0.1 minutes to about 7 minutes. The audio file may be MP3, WAVE, Ogg, or another file format, and may be a single track file or a multi-track file. Data may be loaded onto the media 410 using an interface 422 when the device 100 is manufactured, or may be loaded by an operator after manufacture. In an embodiment, the interface 422 is a universal serial bus (USB) connector. The media 410 includes software programming for operational management of the device 100, and power management of the device 100, such as detecting a low voltage of the device 100. The programming includes an ability to reset the device 100 similar to restarting a locked personal computer.

Audio data is played through the speaker 406, and video data is played through an optional external display 422. The speaker 406 is connected to the processor 412 by the amplifier 408. The amplifier 408 receives audio signals accessed by the processor 412 from the media 410. In an embodiment, the amplifier 408 is a bridge type class D amplifier providing low voltage operation, biased with the available 3.8 volts DC. The amplifier 408 current is 130 milliamps at maximum value. The speaker 406 operates on about 0.25 watts to about 0.50 watts, with about 8 ohms of resistance. In an embodiment, the audio bandwidth is about 3.7 kilohertz or greater. In an embodiment, the speaker 406 is a weatherproof speaker.

In an embodiment, a voltage level detector 234 is operably connected to the capacitor assembly 232 and the second converter 420. The detector 234 is programmed to permit playback of the data stored on the media 410 when the capacitor 232 has reached at least 8.2 volts, and controls the second converter 420 to output 3.8 volts DC +/− 0.1 volts DC.

A mechanical interface 418 accessible from the exterior of the housing 102 is connected to the audio assembly 400 circuitry allowing an operator to transfer software and data to and from the media 410.

In an embodiment, a counter device 428 is operably connected to the processor 412 for tracking the number of times the recorded data is played through the speaker 406. In an embodiment, the media 410 stores count data corresponding to the number of times the recorded data is played through the speaker 406. In an embodiment, the counter device 428 is an operator display device connected to the interface 418 for displaying the playback count value of the module 100. An operator can reset the counter 428 to zero. In an embodiment, the counter device 428 includes a wireless transceiver for communication with the wireless transceiver 432 of the device 100 for retrieving the count value, and for resetting the count value to zero.

In use, for the device 100 having a dynamo 222, first the operator rotates the hub 208 using the hand crank 244 connected thereto to rotate the dynamo 222, thereby generating electrical power for operating the device 100. Rotation of the dynamo 222 generates electrical energy that is stored in the capacitors 232. As the dynamo 222 turns, indicator light 325 illuminates indicating the dynamo 222 is being rotated rapidly enough that electricity is being generated. The amount of energy needed is determined by the software stored in the media 410 and executed by the processor 412, and dependent upon the playback length of the data file. The processor 412 calculates the energy required to playback the recorded data. Once the voltage level detector 234 senses the capacitor assembly 232 has enough charge to power playback of the data recorded on the media 410, indicator light 324 illuminates showing an operator the device 100 is ready for playback. When the device 100 has sufficient power to operate, an operator actuates button 320 to begin playback of the data recorded on the media 410. Actuation of button 320 during playback stops playback of the data and light 324 flashes. If button 320 is pushed when light 324 is flashing the data will resume playback from the stopping point. Once light 324 stops flashing and goes out the device 100 will turn off, and the dynamo 222 will need to be rotated to recharge the capacitor assembly 232, and data playback will resume from the beginning. Upon completion of the playback of the data file, the power stored in the capacitor 232 may be exhausted leaving the power status of the device 100 depleted and the device 100 in an unpowered resting state, thus pushing any of the actuator buttons 320 will not affect the device. In an embodiment, a full charge of the capacitor assembly 232 plays back an entire data message stored on the media 410 without a need for continued power input, such as rotating the dynamo 222. The minimum charge time is dependent on the message length. In an embodiment, an audio and video decoder 430 is connected to the processor 412 for decoding the audio and video codec data file stored on the media 410.

The device 100 may be used as a storytelling device or as an emergency communication device. The device 100 may be located indoors or outdoors, and is capable of operation with or without externally supplied power. The device 100 can have a static message recorded on the media 410, or an updatable message recorded on the media 410. The device 100 can be used for: (a) funeral environments, including a headstone, free-standing, columbarium, or monolith; (b) historical environments, including scenic lookouts, monuments, statutes, and historical reference; (c) tourism environments, including self-guided tours, current events, special events, advertising, and marketing; (d) informational environments, including weather, and current events; (e) tribute environments, including fallen heroes (soldiers, police, firemen), esteemed educators. In some embodiments, the audio device plays a recorded message conveying information associated with its specific use, such as a custom message telling a specific story of a deceased person.

In an embodiment, the device 100 can communicate with a third party, such as law enforcement or an emergency responder by a radio frequency transceiver 432 connected to the processor 412. Thus, the device 100 operates as an emergency system for sending and receiving audio data to and from law enforcement. In an embodiment, a pre-recorded audio message requesting help is stored on the media 410, along with a specific, unique identifier associated with the device 100 that is transmitted by the device 100 and received by a law enforcement office. The law enforcement office plays the help message on a device, and correlates the specific, unique identifier with information identifying the specific geographic location of the device 100. Upon transmission of the help message, the device 100 can play a pre-recorded audio confirmation message to the operator indicating the message was sent. A return signal can be sent by the law enforcement office to the device 100 initiating playback of a pre-recorded audio receipt message to the operator indicating the help message was received by the law enforcement office. In an embodiment, the device 100 includes an image capture device, such as a camera, for capturing images of the operator of the device 100. The captured image is stored on the media 410, and can be transmitted to the law enforcement office allowing an emergency responder to identify the operator. Capturing images of the operator also allow law enforcement to track and deter vandalism and misuse.

In an embodiment, the device 100 transmits an emergency data signal including the unique identifier to a law enforcement office when an operator turns the handle and presses one of the actuator buttons. In an embodiment, the emergency data signal includes a string of numbers that identifies the specific transmitting device 100 allowing a law enforcement office to locate the emergency device 100. In an embodiment, location information can be provided to the device 100 by a global positioning system (GPS) device 434 or other computing device connected to the device 100. The GPS device and the corresponding software used with the GPS device can provide location information to the device 100. In an embodiment, the transmitted emergency data signal includes GPS data identifying the location of the device 100. The GPS device 434 can be programmed or configured to provide or send location information to the processor 412 at any desired interval ranging between fractions of a second to multiple seconds.

In a situation of a natural or manmade disaster, a pre-recorded message in any language can be loaded on the media 410 for playback by the device 100, and the device 100 can be dropped from the air to the people in need. The pre-recorded message could include instructions best suited to help people in the particular situation, such as staying put, move to a rescue location, move to a shelter, etc. Such a device 100 may include a pre-charged battery powered illumination device 436, including a flashlight or a strobe light, to ensure the device can be located by the people in distress.

Devices 100 located in remote locations, such as parks, recreational areas, forestry areas, etc. can be modified to accept updated or replacement data from a laser system. The device 100 would include a target 438 that can be illuminated with a laser from a great distance. The laser beam would serve as both an energy source to activate the device 100, and could be converted by the device 100 into an energy source. The beam would also serve as a carrier of a data for storing and playback by the device 100.

The device 100 can communicate with third parties by any suitable wireless communications technique or protocol. For example, the device 100 can communicate with emergency responders through cellular or satellite communication technology. It is to be understood that the device 100 incorporates the appropriate hardware, e.g. radio frequency transceiver 432, amplifiers, etc., and/or software to enable effective communication for the corresponding wireless technology, including Bluetooth® wireless data exchange protocols.

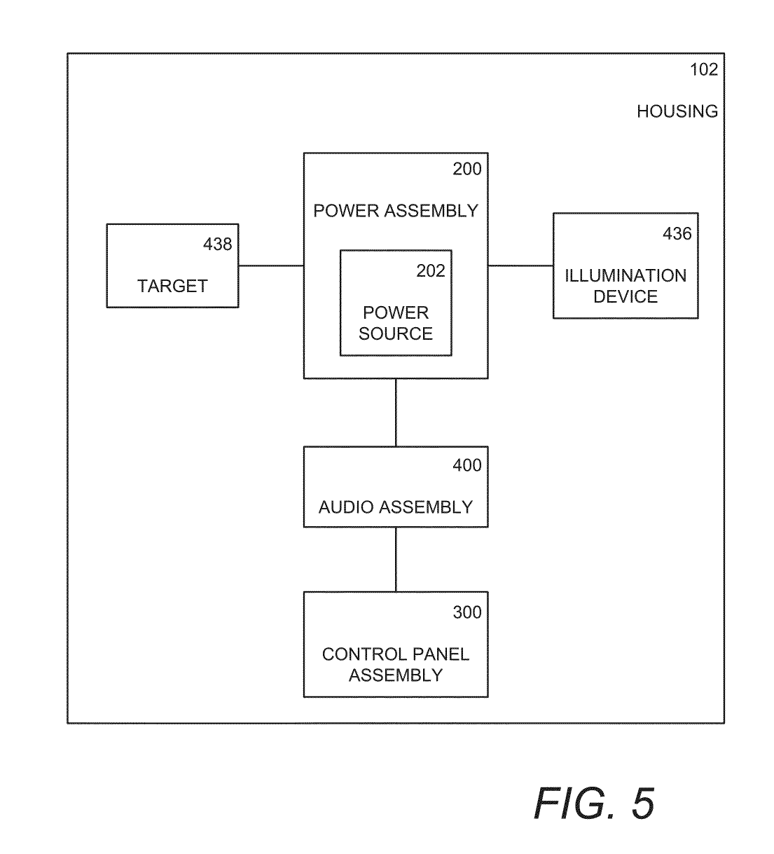

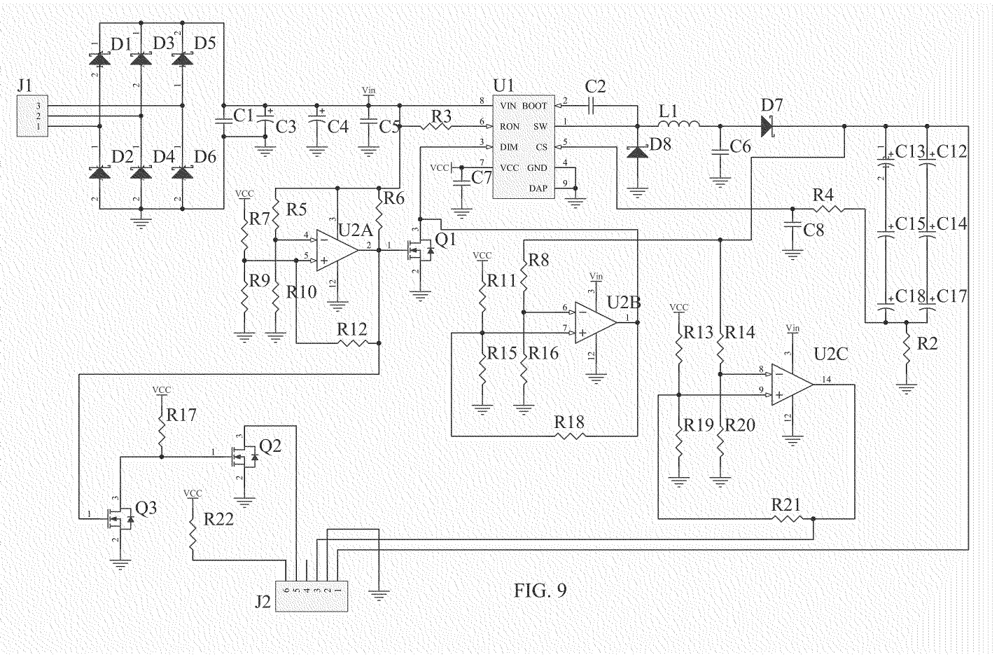

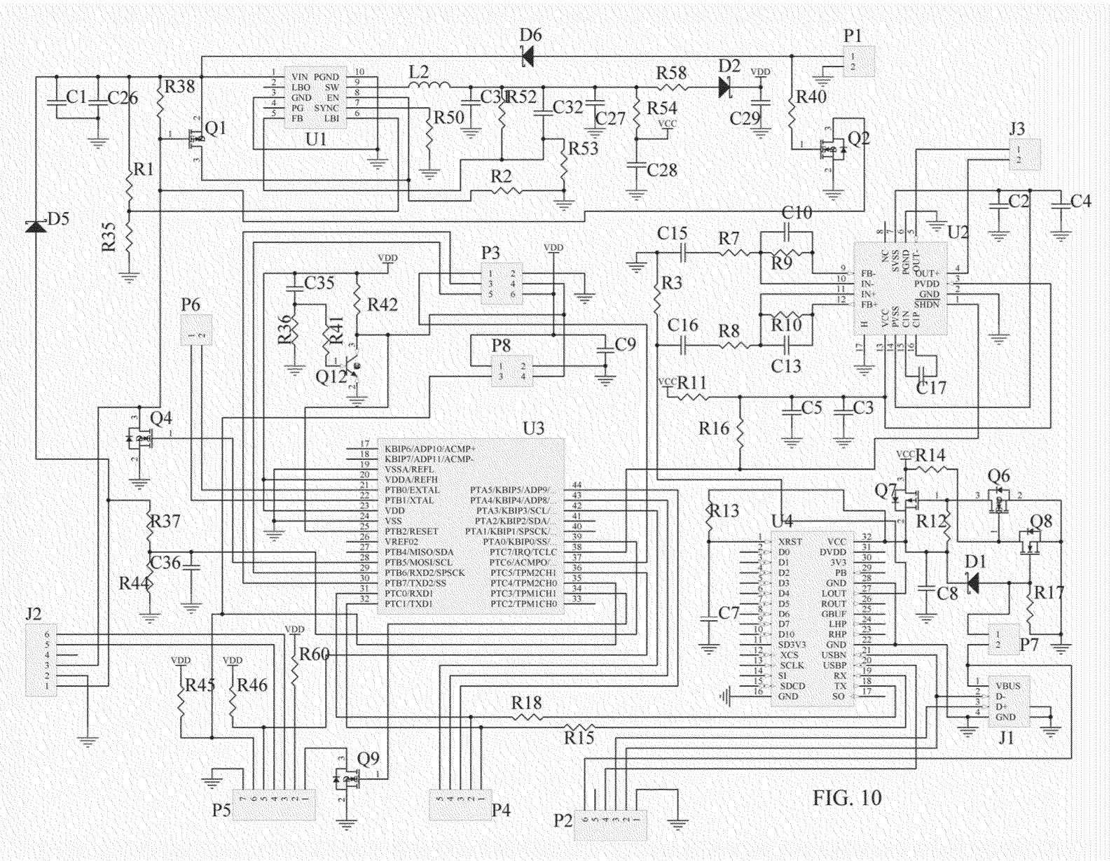

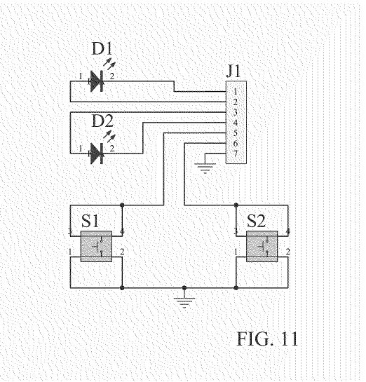

FIG. 9 is a schematic of an embodiment of a power assembly 200 and associated circuitry embodying principles of the disclosed subject matter. FIG. 10 is a schematic of an embodiment of an audio assembly 400 and associated circuitry embodying principles of the disclosed subject matter. FIG. 11 is a schematic of an embodiment of a control panel assembly 300 embodying principles of the disclosed subject matter. The aforementioned circuitry assemblies are interconnected as represented by FIG. 5, in particular connector J2 of the power assembly of FIG. 9 is connected to connector J2 of the audio assembly of FIG. 10, connector J2 of FIG. 10 is connected to connector P5 of FIG. 10, and connector P5 of FIG. 10 is connected to connector J1 of the control panel assembly 300 of FIG. 11.

Referring to FIG. 9, circuitry interconnects a dynamo 222, represented by generator J1, to a capacitor assembly 232, represented by capacitors C12-15, and C18-19 via rectifier 230, represented by diodes D1-D6, and comparators U2A-C. Generator J1 is connected to a light emitting diode (LED) driver U1 at input VIN and RON through diodes D1-D6, and capacitors C1, and C3-C5, and resistor R3. The LED driver U1 is a switching regulator for delivering a constant current to LED D2, for indicating the proper charging voltage is being generated by rotation of the dynamo 222 and provide voltage regulation and over-voltage comparator. Current exits the driver U1 at output SW passing through inductor L1 and rectifier D7 into the capacitor assembly 232. The capacitor assembly 232 includes a first set of capacitors C12, C14, and C17. A second set of capacitors is represented by capacitors C13, C15, and C18. In an embodiment the capacitor assembly 232 includes one or both of the first and second set of capacitors. Supply voltage from the capacitor assembly 232 is provided to the audio assembly 400 by connector J2 of FIG. 9. Driver U1 passes a signal to the charge LED or LED D2 on the control panel circuitry through transistors Q3 and Q2, and connector J2 of FIG. 9. LED D2 receives supply voltage from the power assembly 200 through connector J1 of FIG. 11, via connectors J2 and P5 of FIG. 9, and connector J2 of FIG. 9. Comparator U2A has input resistors R7, R5, R9, and R10, and feedback resistor R12 providing a comparator signal output of gate voltage that enables U1 when the crank charging voltage reaches a high enough level to drive transistor Q1 that provides storage capacitor voltage level and comparator reference for comparator U2B. The output of U2B will disable U1 output when the storage capacitors C12-15, and C17-18 reach a high enough voltage level. Comparator U2B has input resistors R11, R8, R15, and R16, and a feedback resistor R18 providing storage capacitor voltage level and comparator reference for U2C. Comparator U2C has input resistors R13, R14, R19, and R20, and a feedback resistor R21 and provides an audio enable signal output to the audio assembly 400 through connector J2 of FIG. 9 and connector J2 of FIG. 10.

FIG. 10 is a schematic of an embodiment of an audio assembly 400 and associated circuitry embodying principles of the disclosed subject matter. Referring to FIG. 10, circuitry interconnects a processor 412, represented by microcontroller U3 to media 410, represented by audio module U4, and amplifier 408, represented by amplifier U2, and a converter 420, represented by step down converter U1. Microcontroller U3 and amplifier 408 receive supply voltage from the power assembly 200 through connector J2 of FIG. 9 and connector P5 of FIG. 10.

The microcontroller U3 controls communications among, in part, the control panel assembly 300, audio module U4, and amplifier U2. Output PTC3 of the microcontroller U3 is connected through transistor Q9, through connectors P5 of FIG. 10 and connector J1 of FIG. 11, for driving ready indicator LED D1. Output PTC4 of the microcontroller U3 is connected through connector P5 of FIG. 10 and connector J1 of FIG. 11 for receiving signals from the start/stop switch S2. Output PTC5 of the microcontroller U3 is connected through connector P5 of FIG. 10 and connector J1 of FIG. 11 for receiving signals from the volume switch S1.

Output terminal PTC1 of the microcontroller U3 is connected to the serial port receiving terminal RX of the audio module U4 through resistor R15 for transmitting serial data from microcontroller U3 to audio module U4. Serial port transmission terminal TX of the audio module U4 is connected to microcontroller U3 input terminal PTC0 through resistor R18 for transmitting serial data from audio module U4 to microcontroller U3.

Output terminal LOUT of the audio module U4 is connected to input terminals FB− and IN− of amplifier U2 through resistors R3, R7, and R9, and capacitors C10 and C15. Output terminal LOUT of the audio module U4 is connected to input terminals FB+ and IN+ of amplifier U2 through capacitors C16 and C13, and resistors R8 and R10. The audio module U4 is connected to a universal serial bus (USB) connector J1 for moving data to and from the memory. Output terminal VCC of the audio module U4 is connected through transistors Q7, Q6, Q8, diode D1, and resistors R14, R12, and R17 to the VBUS terminal of a connector J1, providing supply voltage. Terminal USBN of audio module U4 is connected to terminal D− of USB connector J1, and USBP is connected to terminal D−.

Auxiliary power can be provided to the input of the audio assembly power supply through header P1, and auxiliary supply voltage is supplied to the step down converter U1 through diode D6 and input voltage pin VIN.

FIG. 11 is a schematic of an embodiment of a control panel assembly 300 embodying principles of the disclosed subject matter. Indicator lights 324 and 325, are represented by light emitting diode (LED) D1 and D2, respectively. Actuator buttons 320 and 322 are represented by switches S1 and S2, respectively. Components of the control panel assembly 300 accessible from the exterior of the body 104 include volume button 320 corresponding to switch S1, and, an actuation button 332 corresponding to switch S2, and indicator light 324 corresponding to LED D1, and indicator light 325 corresponding to LED D2.

It will be appreciated that the components of the device can be used for various other applications. Moreover, the device can be fabricated in various sizes and from a wide range of suitable materials, using various manufacturing and fabrication techniques.

It is to be understood that while certain aspects of the disclosed subject matter have been shown and described, the disclosed subject matter is not limited thereto and encompasses various other embodiments and aspects.

1. An electronic device, comprising:
a housing;
audio circuitry within the housing, comprising:
a media configured to store audio data;
a speaker configured to convert the audio data into sound; and
a processor configured to retrieve the audio data from the media and communicate the audio data to the speaker;
power circuitry coupled to the audio circuitry configured to power the audio circuitry.

2. The device of claim 1, further comprising:
a power source operably connected to the power circuitry;
a dynamo operably connected to the power source; and
a hub at the exterior of the housing operably connected to the dynamo for rotating the dynamo.

3. The device of claim 2, wherein the hub includes an image.

4. The device of claim 2, wherein the power source is a capacitor assembly.

5. The device of claim 2, wherein the power source is a rechargeable battery.

6. The device of claim 2, wherein rotation of the dynamo generates current charging a battery operably connected to the power circuitry.

7. The device of claim 1, further comprising:
a power source operably connected to the power circuitry;
a first connector at the exterior of the housing operably connected to the power circuitry, comprising:
a first generally planar contact surface;
a second generally planar contact surface; and
wherein the first and second contact surface cooperate with an external device providing a power source for powering the electronic device.

8. The device of claim 7, wherein the first connector first and second contact surfaces are concentric.

9. The device of claim 1, further comprising:
a counter device operably connected to the audio circuitry for reading count data stored on the media indicating the number of times the recorded data is played through the speaker.

10. An electronic device, comprising:
a housing;
audio circuitry within the housing, comprising:
a media configured to store audio data;
a speaker configured to convert the audio data into sound; and
a processor configured to retrieve the audio data from the media and playback the audio data through the speaker;
power circuitry coupled to the audio circuitry configured to power the audio circuitry;
control circuitry, comprising:
a switch for initiating playback of the audio data through the speaker; and
a switch for controlling the volume of the speaker.

11. The device of claim 10, further comprising:
a capacitor assembly operably connected to the power circuitry;
a dynamo operably connected to the power source, wherein rotation of the dynamo generates current charging the capacitor assembly.

12. The device of claim 11, further comprising a gear set operably connecting to the dynamo.

13. The device of claim 12, wherein the gear set has a reduction ration of about 27:1.

14. The device of claim 11, wherein the control circuitry further comprises an enable/disable circuit for controlling initiation of the playback of the audio data.

15. The device of claim 10, further comprising an image capture device storing an image data on the media.

16. The device of claim 10, further comprising a target operably connected to the power circuitry for converting light energy into electrical energy to power the electronic device.

17. The device of claim 16, wherein the target converts light energy into audio data.

18. An electronic device, comprising:
a weatherproof housing;
audio circuitry within the housing, comprising:
a media configured to store audio data;
a weatherproof speaker configured to convert the audio data into sound; and
a processor configured to retrieve the audio data from the media and playback the audio data through the speaker;
power circuitry coupled to the audio circuitry within the housing configured to power the audio circuitry, comprising:
a capacitor assembly operably connected to the power circuitry;
a dynamo operably connected to the power source, wherein rotation of the dynamo generates current charging the capacitor assembly;
a rotatable hub at the exterior of the housing; and
a gear set connecting the dynamo and hub.

19. The electronic device of claim 18, further comprising:
control circuitry, comprising:
a switch operably connected to the audio circuitry for initiating playback of the audio data through the speaker;
a switch operably connected to the audio circuitry for controlling the volume of the speaker;
an indicator light operably connected to the power circuitry illuminating when the dynamo is rotating at a rate sufficient to charge the capacitor assembly; and
an indicator light operably connected to the power circuitry illuminating when capacitor assembly is sufficiently charged to playback the audio data.

20. The electronic device of claim 18, wherein rotation of the dynamo generates current charging a battery operably connected to the power circuitry.
